(19) United States
(12) Patent Application Publication
(10) Pub. No.: US 2015/0213219 A1
(43) Pub. Date: Jul. 30, 2015

(54) SYSTEM AND METHOD OF REMOTELY OBTAINING AND RECORDING HEALTHCARE CODES VIA A DYNAMIC INFORMATION GATHERING SYSTEM

(71) Applicant: RSA MEDICAL LLC, Naperville, IL (US)

(72) Inventors: Gregg Lowell Antenen, Naperville, IL (US); Rocco Salviola, III, Naperville, IL (US)

(73) Assignee: RSA MEDICAL LLC, Naperville, IL (US)

(21) Appl. No.: 14/202,708

(22) Filed: Mar. 10, 2014

Related U.S. Application Data
(60) Provisional application No. 61/932,220, filed on Jan. 27, 2014.

(51) Int. Cl. G06F 19/00

(52) U.S. Cl. CPC G06F 19/3431; G06F 19/3418

(57) ABSTRACT

The present disclosure generally relates to dynamic information gathering systems and methods for automatically generating data representative of healthcare codes. In particular, the present disclosure relates to dynamic information gathering systems and methods for automatically generating data representative of healthcare codes that are based on personal information of a patient and patient electronic medical records. The personal information of the patient may be remotely obtained via a series of questions and a series of corresponding answers from the patient where at least one latter question is dynamically determined based on an answer to a former question.

### RELATED APPLICATIONS

This application claims priority under 35 U.S.C. 119(b) to commonly assigned U.S. provisional patent application Ser. No. 61/932,220, which was filed on Jan. 27, 2014, the entire disclosure of which is incorporated by reference herein.

### TECHNICAL FIELD

The present disclosure generally relates to dynamic information gathering systems and methods for automatically generating data representative of healthcare codes. In particular, the present disclosure relates to dynamic information gathering systems and methods for automatically generating data representative of healthcare codes that are based on personal information of a patient and patient electronic medical records.

### SUMMARY

A computer implemented dynamic information gathering method for generating data representative of healthcare codes may include receiving, at one or more processors, data representative of member non-personal information and data representative of member non-HIPAA information. The method may further include automatically generating, using one or more processors, data representative of pre-call information, wherein the data representative of the pre-call information is based, at least in part, on the data representative of the member non-personal information and the data representative of the member non-HIPAA information. The method may also include receiving, at one or more processors, data representative of member personal information, wherein the member personal information is remotely obtained via a series of questions and a series of corresponding answers from the member and wherein the processor dynamically determines at least one question based on the data representative of the pre-call information. The method may yet further include automatically generating, using one or more processors, data representative of at least one healthcare code associated with the member based on the data representative of the member personal information.

In another embodiment, a computer system for remotely and dynamically gathering information that may be used to generate data representative of healthcare codes may include a member non-personal information receiving module stored on a memory that, when executed by a processor, causes the processor to receive data representative of member non-personal information. The computer system may also include a member non-HIPAA information receiving module stored on a memory that, when executed by a processor, causes the processor to receive data representative of member non-HIPAA information. The computer system may further include a pre-call data generation module stored on a memory that, when executed by a processor, causes the processor to automatically generate data representative of pre-call information, wherein the data representative of the pre-call information is based, at least in part, on the data representative of the member non-personal information and the data representative of the member non-HIPAA information. The computer system may yet further include a member personal information receiving module stored on a memory that, when executed by a processor, causes the processor to generate data representative of member personal information, wherein the member personal information is remotely obtained via a series of questions and a series of corresponding answers from the member and wherein the processor dynamically determines at least one question based on the data representative of the pre-call information.

In a further embodiment, a non-transitory computer-readable medium storing instructions for remotely and dynamically gathering information that may be used to generate data representative of healthcare codes may include a member non-personal information receiving module that, when executed by a processor, causes the processor to receive data representative of member non-personal information. The non-transitory computer-readable medium may further include a member non-HIPAA information receiving module that, when executed by a processor, causes the processor to receive data representative of member non-HIPAA information. The non-transitory computer-readable medium may also include a pre-call data generation module that, when executed by a processor, causes the processor to automatically generate data representative of pre-call information, wherein the data representative of the pre-call information is based, at least in part, on the data representative of the member non-personal information and the data representative of the member non-HIPAA information. The non-transitory computer-readable medium may yet further include a member personal information receiving module that, when executed by a processor, causes the processor to generate data representative of member personal information, wherein the member personal information is remotely obtained via a series of questions and a series of corresponding answers from the member and wherein the processor dynamically determines at least one question based on the data representative of the pre-call information.

### BRIEF DESCRIPTION OF THE DRAWINGS

The figures described below depict various aspects of the systems and methods disclosed herein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an example block diagram of a functional diagram for a qualified telemedicine assessment and risk analysis process;

FIG. 2 depicts an example block diagram of a logical diagram of a platform for the qualified telemedicine assessment and risk analysis process of FIG. 1;

FIG. 3 depicts an high level block diagram of an example computer system for use with the qualified telemedicine assessment and risk analysis process of FIG. 1;

FIG. 4 depicts a flow diagram of an example method of generating data representative of pre-call information for use with the qualified telemedicine assessment and risk analysis process of FIG. 1;

FIG. 5 depicts a flow diagram of an example method of generating data representative of personal information of a member via a telemedicine interview between a clinician and a member for use with the qualified telemedicine assessment and risk analysis process of FIG. 1; and

FIG. 6 depicts a flow diagram of an example method of generating data representative of at least one healthcare code for use with the qualified telemedicine assessment and risk analysis process of FIG. 1.

### DETAILED DESCRIPTION

The systems and methods of the present disclosure provide a qualified telemedicine assessment and risk analysis process. The qualified telemedicine assessment and risk analysis process may be a comprehensive telemedicine services platform that facilitates two-way, real time interactive communication between a health insurance plan member and a licensed clinician. The interaction between the health insurance plan member and the licensed clinician may be individually designed to complete a comprehensive medical needs assessment and to align those needs with benefit administration and care maximization. This process may utilize a telecommunication system and a rules based medical assessment engine to interactively interpret vast amounts of data and to dynamically customize the dialogue between the member and the clinician. The member may be engaged to assess their current health needs while generating health assessments and output used by the healthcare system stakeholders; specifically the member, the physician and the insurance carrier. The healthcare system stakeholders may benefit from improved quality and continuity of care through accurate and portable documentation, identification of gaps and redundancy in care, and reduction in costs by eliminating errors, redundancy and gaps in documentation.

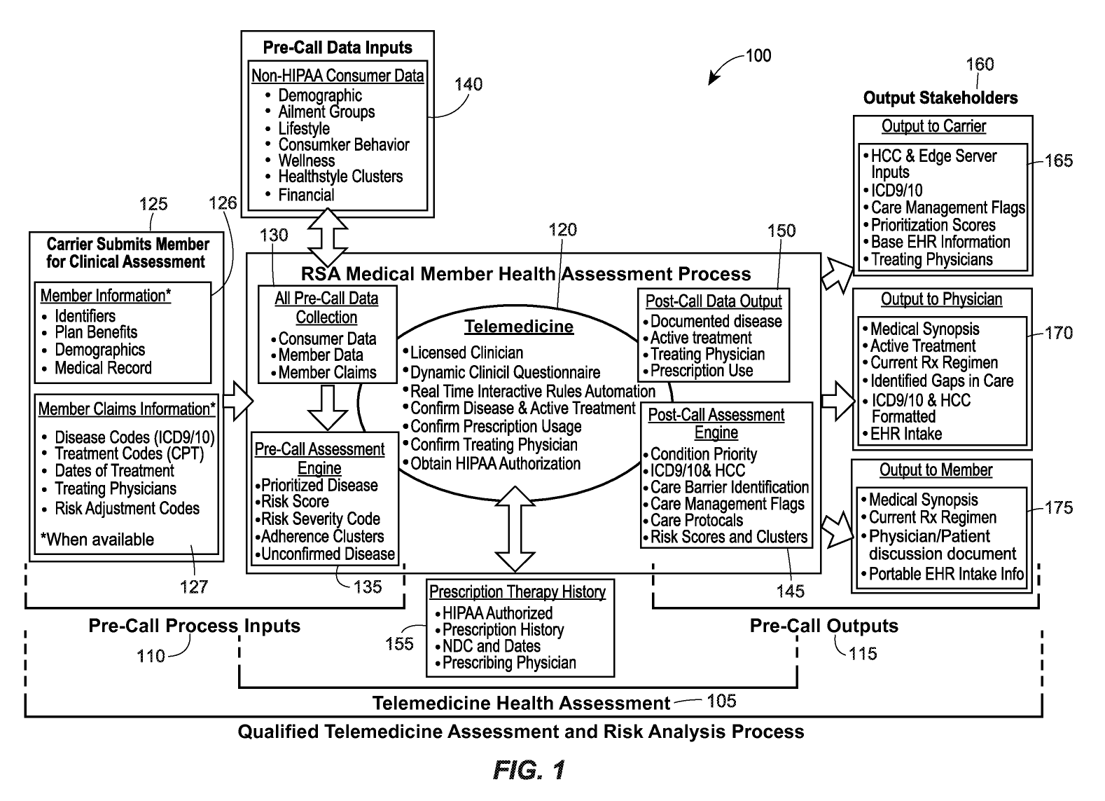

Turning to FIG. 1, a qualified telemedicine assessment and risk analysis process functional diagram 100 is depicted that may include pre-call process inputs 110, a telemedicine health assessment 105, and post-call outputs 115. The pre-call process inputs 110 may begin when an insurance carrier submits a member for clinical assessment 125. The clinical assessment 125 may include member information 126 when available, such as identifiers, plan benefits, demographics and medical records. The clinical assessment 125 may further include member claims information 127 when available, such as disease codes (e.g., ICD 9/10 codes), treatment codes (e.g., CPT codes), dates of treatment, treating physicians and risk adjustment codes. The pre-call process inputs 110 may further include pre-call data inputs (e.g., non-HIPAA consumer data), such as demographic, ailment groups, lifestyle, consumer behavior, wellness, healthstyle clusters and financial.

The telemedicine health assessment 105 may include all pre-call data collection 130, such as consumer data, member data and member claims. The telemedicine health assessment 105 may further include a pre-call assessment engine 135 that may prioritize member disease, provide a member risk score, provide a member risk severity code, provide member adherence clusters and provide unconfirmed member disease. The telemedicine health assessment 105 may also include a member prescription therapy history 155, such as HIPAA authorized, prescription history, NDC and dates and prescribing physician. The telemedicine health assessment 105 may yet further include a telemedicine portion 120 where a licensed clinician may confirm member disease and active treatment, confirm member prescription usage, confirm member treating physician information and obtain member HIPAA authorization via a dynamic clinical questionnaire that may be based on a real-time interactive rules automation process. The telemedicine health assessment 105 may also include post-call data output, such as documented member disease, member active treatment, member testing physician and prescription use. The telemedicine health assessment 105 may further include a post-call assessment engine that may assess member condition priority, generate ICD 9/10 and HCC codes, identify member care barriers, generate member care management flags, generate member care protocols and generate member risk scores and clusters.

The post-call outputs 115 may include output to stakeholders 160. The output to stakeholders 160 may include output to a member insurance carrier 165, outputs to a member physician 170 and outputs the member 175. The output to a member insurance carrier 165 may include HCC and edge server inputs, ICD 9/10 codes, care management flags, prioritization scores, base EHR information and a list of member treating physicians. The output to the physician 170 may include member medical synopsis, active member treatment, current member Rx regiment, identified gaps in member care, formatted member associated ICD 9/10 and HCC codes and EHR intake. The output to the member 175 may include a member medical synopsis, a member current Rx regiment, a physician/patient discussion document and portable EHR intake information.

The Functional Diagram 100 of FIG. 1 illustrates how elements may be integrated to form a qualified telemedicine assessment and risk analysis process 105. The process may have many moving elements each contributing additional functionality and shaping the interaction between people and computers. The qualified telemedicine process 105 may consist of three core areas of functionality; pre-call process inputs 110, the telemedicine health assessment 120 and the post-call outputs 115. The pre-call process 140 may be focused on collecting a broad set of data points that create an initial unconfirmed assessment of the member. This assessment may generate quality and prioritization measures while guiding the content of the telemedicine interaction. The inputs to the pre-call process 110 may consist of member information 126, member claims information 127 and non-HIPAA consumer data 140. The data may complete a validity check and then may be assessed via a pre-call assessment engine 135.

To begin the process the carrier may submit member identifiers 125. In addition to basic identifying information the carrier may submit plan benefit details, member demographics and medical record information when available. This information may be used to search for additional information, but more importantly, may be used to feed an assessment of an alignment of benefits and disease with current care needs.

The carrier may submit, when available, past claims history. With most new members this information is not available from the carrier. When the past claims history is available, the claim history may be used to establish initial assessments and prioritize data points that may be confirmed while determining indicators for care needs and likely protocols. All data may be coded such that it can improve the efficiency and accuracy of care documentation while allowing clinicians to focus on giving care.

Consumer behavior data (e.g., Non-HIPAA Consumer Data) 140 may be gathered on each member from a broad series of data sources available in the industry. The data elements gathered do not require HIPAA authorization and may provide a portrait of the member that may assist with the interaction between the member and the clinician. The sources 140 may consist of demographic information including consumer behavior, lifestyle and financial indicators. Additional member insight may be gained from wellness, ailment and health style clusters.

Pre-call data 130 may be gathered and validated prior to entry into a pre-call assessment engine 135. The pre-call assessment engine 135 may translate the data and may apply complex algorithms which may evaluate a broad set of variables and their attributes based on subpopulation segmentations. The algorithms may generate disease indicators of likely care engagement, care preferences and healthcare expense. The development and validation of the algorithms may be based on large datasets containing years of claims and care experience.

Using the inputs from the pre-call member assessment, the telemedicine process 105 may be designed to assess the member's current medical needs for proper alignment of benefits administration and care maximization while facilitating communication across the carrier, provider and member. Beginning with the pre-call assessment 135, the telemedicine service may bring the power of real-time interactive rules-based automation and dynamic clinical questionnaires together with the care of licensed clinicians to prioritize patients and generate prompts or initiate calls to the prioritized patients.

The member and clinician interaction may be guided by a real-time interactive rules engine. As the clinician confirms the current state of disease via the dynamic clinical questionnaire, the rules engine may be constantly evaluating the information against thousands of rules to produce real-time clinical assessments of care needs and continuity of care opportunities. The rules may generate actions specific to each member such that individualized recommendations and communication outputs are generated. The benefit of which is the member receiving the right care, at the right time, in the right place.

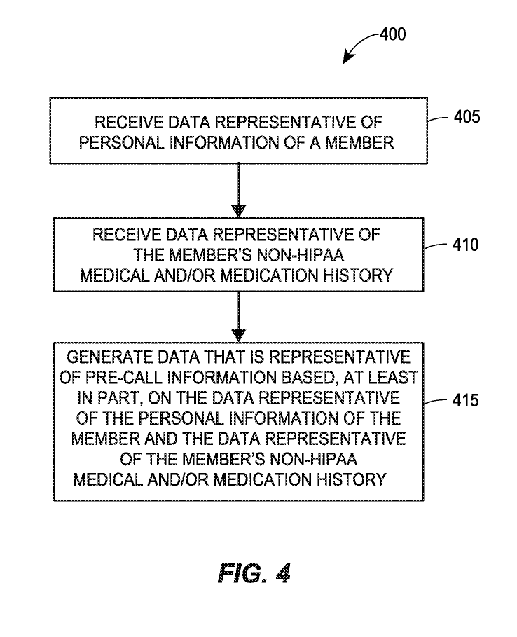

The rules engine's effectiveness may be strengthened by a close integration with a dynamic clinical questionnaire. At the core of the questionnaire may be methods of creating a natural clinician/patient engagement that allows for a comfortable flow of disease discovery. The flow of questions may be dynamically generated (e.g., as in the method of FIG. 4) and may create data that is digested by the rules engine in real time.

With the authorization of the member, the member's prescription therapy history may be electronically gathered and evaluated. The history may provide an opportunity to accurately discuss the current and past prescription therapy while identifying continuity of care issues, as well as, highlighting possible gaps in active treatment and dangerous drug interactions. Information in the history may be confirmed and formatted for documentation and utilization by the member, physician and carrier.

The member data, rules engines, telemedicine questionnaires may all cohesively enhance the quality of the relationship and care achieved between the clinician and member. Any given clinician may be licensed and may provide ongoing clinical and member engagement training to maximize the member experience.

At the completion of the call, the telemedicine assessment process may have generated a great deal of confirmed clinical information 115 that will serve to improve the care of the member through accurate and portable documentation. The confirmed information may be distributed to the stakeholders 160 through a set of formats that are easily digested. Specific formats may be generated for the member 175, carrier 165 and physician 170.

The member may be provided secure access to a medical synopsis 175 of the telemedicine engagement they completed with the clinician. This serves several quality functions including accurately documenting all of their current states of disease, current medications and treating physicians in one document. As the member visits each provider and especially new providers, the document can be referenced for accurate intake and continuity of care. It can referenced for practical and informed doctor/patient interactions.

The physician may also receive a synopsis of the telemedicine engagement with the main focus to facilitate continuity of care 170. Each condition is documented with current treatment and prescription therapy including treating physician for direct reference as appropriate. The information is provided electronically as data and/or image for population in the EHR. Coding assistance is provided as each disease has both ICD9/10 and HCC coding provided with helpful suggestions for proper completion.

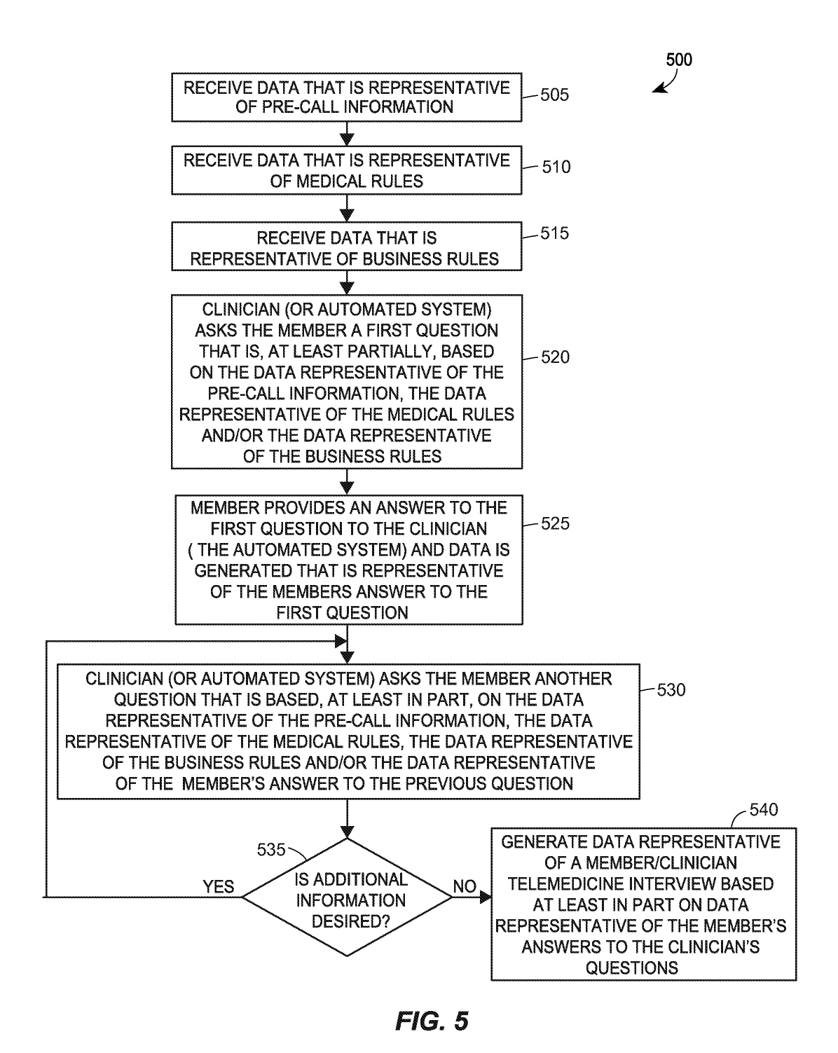

The insurance carrier may receive all information electronically to feed systems to quickly kick-off care management activities and services to the member 165. Coding for ICD9/10, HCC and care management needs (e.g., as in the method of FIG. 5) may be provided to avoid non-care related interactions with providers and members. Edge server compliant coding may be provided for efficient submission to CMS thus reducing costs of administration.

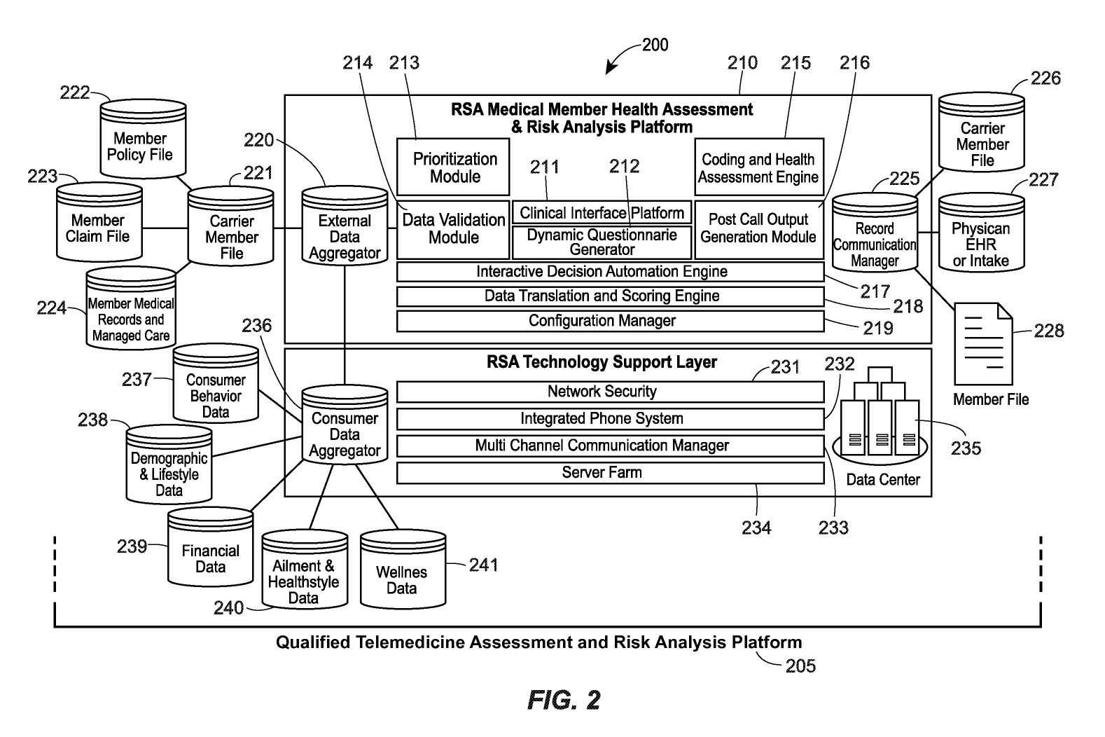

Turning to FIG. 2, a high-level block diagram 200 is depicted that illustrates a qualified telemedicine assessment and risk analysis platform 205. The qualified telemedicine assessment and risk analysis platform 205 may include a technology support layer 230 and a medical member health assessment and risk analysis platform 210. The technology support layer 230, may include a consumer data aggregator 236, network security 231, an integrated phone system 232, a multi-channel communication manager 233 and a data center 235. The consumer data aggregator 236 may aggregate consumer behavior data 237, demographic and lifestyle data 238, financial data 239, ailment and healthstyle data 240 and wellness data 241.

The medical member health assessment and risk analysis platform 210 may include an external data aggregator 220, a prioritization module 213, a data validation module 214, a clinical interface platform 211, a dynamic questionnaire generator 212, an interactive decision automation engine 217, a data translation and scoring engine 218, a configuration manager 219, a coding and health assessment engine 215, a post call output generation module 216 and record communication manager 225. The external data aggregator 220 may aggregate data from a member policy file 222, a member claim file 223, member medical records and managed care 224 and an insurance carrier member file 221. The record communication manager 225 may communicate a carrier member file 226, a physician EHR file or intake 227 and a member file 228.

The logical diagram 200 of FIG. 2 illustrates, for example, the underlying technologies and software components 205 that may support the qualified telemedicine assessment and risk analysis process 100 of FIG. 1. The three core areas that may make up the logical diagram 200 are, pre-call process inputs 236, telemedicine services and post-call process outputs 216, are supported by core software and hardware capabilities 205.

The pre-call process may be supported by three primary modules; data aggregator module 220, data validation module 214, data translation and scoring module 218. These modules may work together to request, retrieve, validate and aggregate the data. Once these processes are completed, the final pre-call scoring module may be activated to calculate scores and clusters to be used by the rules engines and prioritization module.

Aggregator modules (external and consumer data aggregators) may manage the requests from the core system to the data sources by sending request data and receiving the system responses. Each response may be aggregated with other responses for the individual member to generate one full record representing all the member's pre-call information.

A data validation module 214 may take each data point and check the content for validity and may determine if the data value may be stored and submitted to the translation and scoring module 218.

A translation and scoring module may assemble the required data points from the aggregator modules 220, 236 into values that can be processed by the scoring algorithms. The translations may be mathematical or formatting translations. Once translated, the variable may be processed by the scoring algorithms to produce the risk and prioritization scores to be used by the decision engines in the telemedicine process.

A telemedicine process may be supported by a number of technologies that support the clinical care of the member. The integrated phone system 232 and clinical interface platform may provide the direct interaction between the licensed clinician, the member and the telemedicine technologies. As noted in the diagram of FIG. 2, there may be a series of modules, engines and other software components working in concert to complete the member engagement, resulting in the health assessment and care outputs.

A clinician's engagement with the member may be guided by a clinical interface platform. This may be both an interface to gather information and a medical engagement tool to guide the interaction with clinical information and dynamically generated questionnaires. The capture of disease, treatment and prescription and physician information may be dynamic and may flow medically based on standards of care.

An initial call setup may be determined by the pre-call data gathering and scoring fed through the real-time interactive rules engine. As the clinician gathers and confirms information with the member, the dynamic questionnaire generator may be guiding the conversation to match the member's needs with their benefits and current health scenarios. As a result, just the right amount of information may be requested and only information the member is likely to know or can confirm.

The real-time interactive rules engine may gather information directly from the telemedicine phone call as it is occurring and may provide interactive decisions to the dynamic questionnaire generator and onscreen messages to the clinician. Thousands of rules may be running continuously to assess care needs and highlighting continuity of care situations.

During and at the time the telemedicine call is completed, the data translation and scoring engine may run to generate output data, scores and/or codes to impact, among other areas, care management prioritization and population risk analysis.

A configuration manager 219 is a module that may allow setup and management of the rules and questionnaires inside the system through configuration and not through code development. This may allow for quick setup and change to the interface to adapt and continuously improve member post-call process outputs.

Post-call process may be managed by three core engines/modules: a data translation and scoring engine 218, a coding and health assessment engine 215, and a post call output generation module 216. These three modules may work together to produce the outputs received by the three stakeholders (e.g., member 228, physician 227, carrier 226).

Data translation and scoring may be performed on the data one more time to create the output values. To populate the various outputs, data points may be translated to generate outputs in the formats the stakeholders need.

A coding and health assessment engine may provide translation of information gathered and confirmed into the various ICD9/10, HCC and care management codes needed to kickoff downstream care and risk activities with both the physician and the carrier. All common formatting is created and aggregated to create the various report outputs for the users.

A post call output generation module may receive the output of the coding and health assessment engine and may generate images and data formats for transmission and use by the stakeholders. Data may be formatted to standard images for easy viewing but also sent as data for consumption by downstream systems.

All the systems, software modules, engines, databases and users may be supported by common layers of support. The data center may be housed on a server and network security, database and software development and business continuation practices may follow generally accepted industry best practice standards. Phone systems and multi-channel communication capabilities may be top ranked solutions with custom features developed and maintained.

Generally, the systems and methods of the present disclosure may automatically generate data representative of healthcare codes for patients. Data representative of any given healthcare code for any given patient may be based on personal information obtained from the patient via dynamic information gathering. For example, data representative of a healthcare code may be based, at least in part, on answers provided by the patient in response to a series of questions. The systems and methods of the present disclosure may dynamically determine any given question based on an answer provided by the patient in response to a previous question. The data representative of the healthcare code may be further based on data representative of medical records of the patient. The data representative of the healthcare code may be yet further based on data representative of pharmaceutical prescriptions prescribed for the patient. The data representative of the healthcare code may be even further based on data representative of insurance records for the patient. The present systems and methods may be patient centric.

In any event, the systems and methods of the present disclosure may automatically transmit data representative of healthcare codes for any given patient to the patient, to an insurance carrier, to a government database, and/or to a health care provider, such as an attending physician. Furthermore, the systems and methods of the present disclosure may automatically update the data representative of healthcare codes for any given patient based on any new patient data, pharmaceutical data, physician data, insurance data, etc.

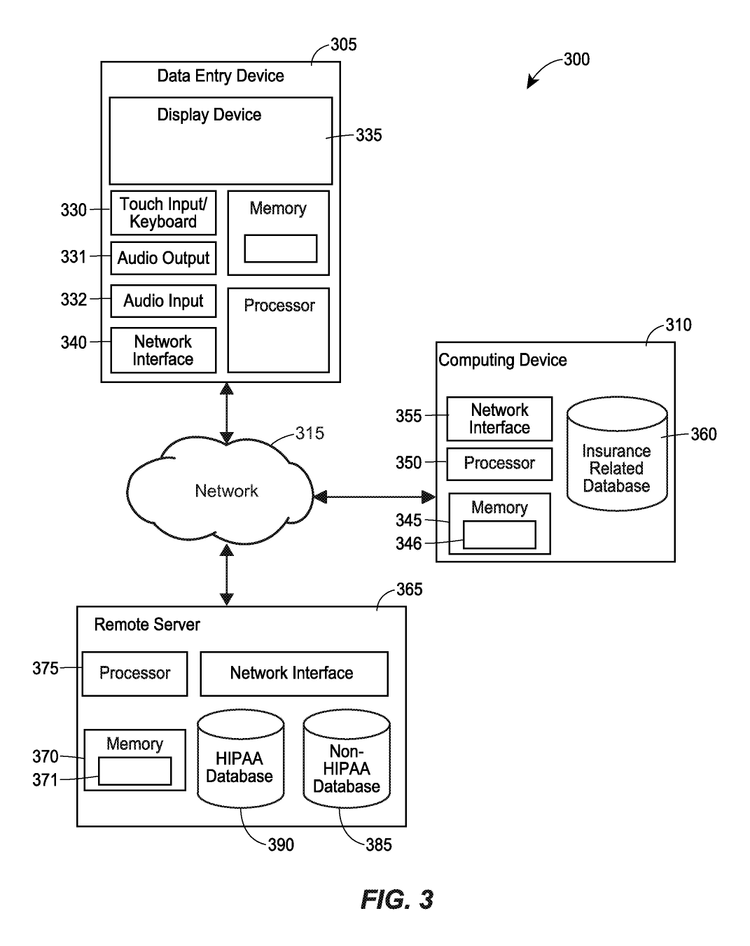

Turning to FIG. 3 a high level block diagram 300 is depicted for a computer system 305 that may acquire data (e.g., data representative of personal information of a member and data representative of a medical and/or medicine history of a member) from a remote server 310 via a communications network 315. The computer system 305 may include a memory 320 storing various modules 321 that, when executed by a processor 325, generate data representative of a health assessment of a member and/or data representative of associated healthcare codes for the member. The computer system 305 may further include a communication network interface 340, a user input mechanism (e.g., a keyboard and/or mouse) and a display.

The remote server 310 may include a memory 345 storing various modules 346 that, when executed by a processor 350, may transmit data (e.g., data representative of personal information of a member and data representative of a medical and/or medicine history of a member) from an insurance related database 360 in the remote server 310 to the computer system 305 via a communications network interface 355.

The insurance related database 360 may include, for example, data representative of an HCC code, an international classification of disease (ICD) procedure coding system or any other healthcare code. In particular, the insurance related database 360 may include data representative of an ICD-10-PCS code system that is an American system of medical classification used for procedural coding. The Centers for Medicare and Medicaid Services (CMS), the agency responsible for maintaining the inpatient procedure code set in the U.S., is replacing Volume 3 of ICD-9-CM with ICD-10-CM. ICD-9-CM contains a procedure classification; ICD-10-CM does not. ICD-10-PCS is the result. ICD-10-PCS was initially released in 1998. It has been updated annually since that time.

Oct. 1, 2011 is the last major update of ICD-9-CM. Any further revisions to ICD-9-CM will only be for a new disease and/or a procedure representing new technology. After Oct. 1, 2011 there will be no further release of ICD-9-CM on CD-ROM. Oct. 1, 2011 is the last major update of ICD-10-CM/PCS until Oct. 1, 2015. Between Oct. 1, 2011 and Oct. 1, 2015 revisions to ICD-10-CM/PCS will be for new diseases/new technology procedures, and any minor revisions to correct reported errors in these classifications. Regular (at least annual) updates to ICD-10-CM/PCS will resume on Oct. 1, 2015. ICD-10-CM/PCS, on CD-ROM will be released one year prior to implementation. ICD-10-CM 2013 Official Guidelines for Coding and Reporting are also available. These ICD codes are incorporated in their entirety herein by reference.

Each ICD-10-CM/PCS code generally consist of three to seven characters. A first character is alphabetical and all letters are used except U. Character 2 is always numeric. Characters 3 through 7 can be alphabetical or numeric. A decimal is placed after the first three characters. Alphabetical characters are not case-sensitive within the codes. ICD-10-CM utilizes a placeholder character “x.” The “x” is used as a placeholder at certain codes to allow for future expansion. An example of this is at the poisoning, adverse effect and under dosing codes, categories T36-T50. Certain ICD-10-CM categories have an applicable 7th character. The applicable 7th character is required for all codes within the category, or as notes in an associated tabular list instruct. The 7th character must always be the 7th character in the data field. If a code that requires a 7th character is not 6 characters, a placeholder X is be used to fill in the empty characters. Expanded detail for many conditions (e.g., viral hepatitis has been expanded from ICD-9 070, a single 3-digit category, to ICD-10 B15-B19, five 3-digit categories. Transferred conditions around the classification (e.g., hemorrhage has been moved from the circulatory chapter to the symptoms and signs chapter).

Creation of combination diagnosis/symptom codes to reduce the number of codes needed to fully describe a condition: I25.110 is the code for atherosclerotic heart disease of native coronary artery with unstable angina pectoris. Two codes are required to classify both diagnosis within the ICD9. The incorporation of common fourth- and fifth-character sub-classifications: F10.14 is the five-character code to report alcohol abuse with alcohol-induced mood disorder. Extensive expansion of the injury codes, allowing for greater specificity: S50.351 is the code for superficial foreign body of right elbow. The 7th character designates the encounter: A-initial encounter, D-subsequent encounter, S-sequela. The addition of the sixth character: S06.336 is the code to report unspecified contusion and laceration of the cerebrum, with loss of consciousness greater than 24 hour without return to pre-existing conscious level with the patient surviving (requires a 7th character to describe the encounter (A, D, or S). Some fracture categories provide 7^{th} character extensions to designate the specific type of open fracture. These designations are based on the Gustilo open fracture classification and apply to categories S52 (Fracture of Forearm), S72 (Fracture of Femur), and S82 (Fracture of Lower Leg). A, Initial encounter for closed fracture B, Initial encounter for open fracture D, Subsequent encounter for fracture with routine healing G, Subsequent encounter for fracture with delayed healing K, Subsequent encounter for fracture with nonunion P, Subsequent encounter for fracture with malunion S, Sequelae.

With reference to FIG. 4, a method of generating data representative of a pre-telemedicine call 400 is depicted. The method 400 may include receiving at a processor (e.g., processor 325 of FIG. 3) data representative of non-personal information of a member (block 405). The processor 325 may further receive data representative of the member's non-HIPAA medical and/medication history (block 410). The method 400 may also include generating data that is representative of pre-call information based, at least in part, on the data representative of the non-personal information of the member and the data representative of the member's non-HIPAA medical and/or medication history (block 415). The member “non-personal” information may include, for example, information that is provided by an insurance carrier (e.g., member information 126, 127 of FIG. 1) rather than information that is provided by the member. Data representative of non-personal information may be received, for example, from any one of the sources 221, 222, 223, 224, 237, 238, 239, 240, 241 of FIG. 2. The member non-HIPAA information may include, for example, pre-call data inputs 140 of FIG. 1.

Turning to FIG. 5, a method of generating data representative of a member/clinician telemedicine interview 500 is depicted. The method 500 may begin with a processor (e.g., processor 325 of FIG. 3) receiving data that is representative pre-call information (block 505). The processor 325 may receive data that is representative of medical rules (block 510). The processor 325 may receive data representative of business rules (block 515). A clinician may ask a member a first question that is, at least partially, based on the data representative of the pre-call information, the data representative of the medical rules and/or the data representative of the business rules (block 520). Alternatively, or additionally, an automated telephonic system (e.g., processor 325 executing a module 321) may be employed to obtain information from the member (block 520). The member may provide an answer to a first question to the clinician (or the automated system) and the processor 325 may receive data representative of the question/answer and may generate data that is representative of the members answer to the first question (525). The clinician, or the automated teleinterview system, may ask the member another question based, at least in part, on the data representative of the member's answer to the previous question, the data representative of the medical rules and/or the data representative of the business rules (block 530). The processor 325 may determine whether additional member information is desired (block 535). For example, the processor 325 may determine that additional information is desired based on an input from the clinician. Alternatively, the processor 325 may automatically determine that additional information is desired based on the data representative of the member's answer to the previous question, the data representative of the medical rules and/or the data representative of the business rules. When the processor 325 determines that additional information is desire (block 535), the processor returns to block 530 and another question is presented to the member. When the processor 325 determines that additional information is not desired (block 535), the processor may generate data representative of the member/clinician telemedicine interview based, at least in part, on the data representative of the member's answers to the questions (block 540). This sequence of questions/answers may proceed until the method of generating data representative of member/clinician telemedicine interview 500 is complete.

The information may include: teleinterviewer's contact information, first name, last name, daytime telephone number and extension, reason patient is being referred, select reason, second opinion, chart review, and other; is patient being referred to a specific physician, if Yes, please enter the physician's name; patient information, first name, last name, street address, city, state, zip code, county, date of birth, month, day, year, gender; patient's diagnosis; diagnosis date, month, day, year; is the patient currently under treatment; current treatment method; past treatment methods; referring physician information, first name, last name, office street address, city, state, zip code, country, office telephone number, office facsimile number, physician E-Mail address; use a clinician; and use telemedicine process. It should be understood that data representative of personal information of a patient may be based on patient disease information, patient medication information, patient behavior information, patient medical and/or mental testing and patient treatment. The data representative of personal information of a patient may represent an overall medical picture for a patient.

For purposes of Medicaid, telemedicine currently seeks to improve a patient's health by permitting two-way, real time interactive communication between the patient, and the physician or practitioner at the distant site. This electronic communication means the use of interactive telecommunications equipment that includes, at a minimum, audio and video equipment. Telemedicine is particularly useful in rural areas where access to health care providers is limited.

Telemedicine is viewed as a cost-effective alternative to the more traditional face-to-face way of providing medical care (e.g., face-to-face consultations or examinations between provider and patient) that states can choose to cover under Medicaid. This definition is modeled on Medicare's definition of telehealth services (42 CFR 410.78). Note that the federal Medicaid statute does not recognize telemedicine as a distinct service. States may select from a variety of health care procedure coding system (HCPCS) codes (T1014 and Q3014), current procedural terminology (CPT) codes and modifiers (GT, U1-UD) in order to identify, track and reimburse for telemedicine services.

Telehealth (or Telemonitoring) is the use of telecommunications and information technology to provide access to health assessment, diagnosis, intervention, consultation, supervision and information across distance. Telehealth includes such technologies as telephones, facsimile machines, electronic mail systems, and remote patient monitoring devices, which are used to collect and transmit patient data for monitoring and interpretation. While they do not meet the Medicaid definition of telemedicine they are often considered under the broad umbrella of telehealth services. Even though such technologies are not considered “telemedicine,” they may nevertheless be covered and reimbursed as part of a Medicaid coverable service, such as laboratory service, x-ray service or physician services (under section 1905(a) of the Social Security Act).

Telemedicine is viewed as a cost-effective alternative to the more traditional face-to-face way of providing medical care (e.g., face-to-face consultations or examinations between provider and patient). As such, states have the option/flexibility to determine whether (or not) to cover telemedicine; what types of telemedicine to cover; where in the state it can be covered; how it is provided/covered; what types of telemedicine practitioners/providers may be covered/reimbursed, as long as such practitioners/providers are “recognized” and qualified according to Medicaid statute/regulation; and how much to reimburse for telemedicine services, as long as such payments do not exceed federal upper limits.

The following information may be obtained from a physician teleinterview with a patient. The physician contact information: name, address, phone number, facsimile number and email address. Information about the patient: name, birth date, address, telephone number, social security number and insurance information. Patient's complete medical history and records: medical history, surgeries/procedures, and devices: type/settings. Description of patient's current medications: type(s), dosages, and allergies. Diagnostic Test reports plus actual films or tracings: cardiac catheterization: actual film plus report, echocardiogram: actual tape plus report, thallium stress test, actual x-ray film plus report, chest X-ray, CT scans, ultrasounds: X-ray films plus report, electrocardiograms: actual tracings if available, electrophysiology testing: actual tracings and reports, any and all blood studies, and any other relevant testing and/or results.

A health or medical record for a patient may include: symptoms, the examination, tests results, diagnosis(es), treatment, and plan of care or follow-up. This information is referred to as your health or medical record and serves as: the basis for planning your care, treatment, and follow-up; a means of communication among all of the healthcare professionals who contribute to your care; a legal document describing the care you've received; a means by which you or a third-party payor can verify the care being billed has actually been provided; a tool to educate healthcare providers; a potential resource for medical research data; a source of information for public health officials, who are responsible for improving the health of the nation; a tool for assessing and improving the care rendered on a continuous basis; and a tool to review and improve outcomes achieved by the healthcare team. Understanding a health record and how this information is used will assist a patient to: ensure its accuracy; better understand who, what, when, where, and why others may access the health information contained in your medical record; and help make informed decisions when authorizing disclosures to others.

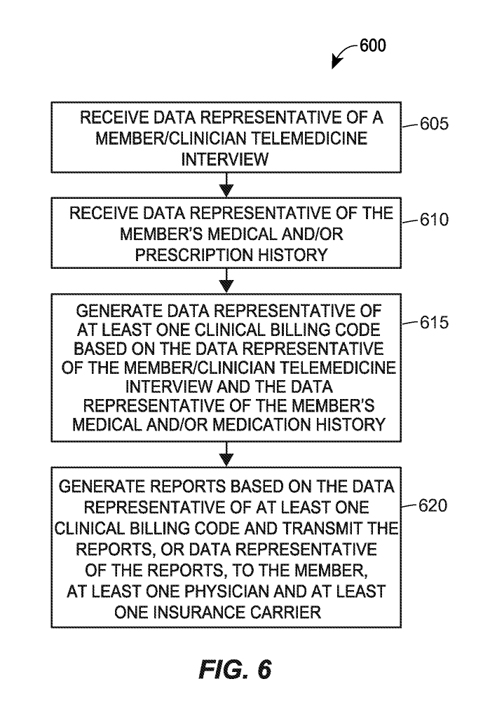

With reference to FIG. 6, an example method of generating data representative of at least one healthcare code and/or data representative of a health assessment of a member 600 is depicted. The method 600 may commence with a processor (e.g., processor 325) receiving data representative of a member/clinician telemedicine interview (block 605). The processor 325 may receive data representative of the member's medical and/or medication history (block 610). For example, the data representative of the member's medical and/or medication history may include a member prescription therapy history 155 of FIG. 1. The processor 325 may generate data representative of at least one healthcare code and/or data representative of a health assessment of a member based on the data representative of the member/clinician telemedicine interview and/or the data representative of the member's medical and/or medication history (block 615). The processor 325 may generate reports based on the data representative of at least one healthcare code and may transmit the report(s), or data representative of the report(s) to the member, to at least one physician and to at least one insurance carrier (block 620).

More generally, the systems and methods of the present disclosure may receive data representative of a patient's historical medical record information, a patient's pharmaceutical prescription and over the counter medication history information, a patient's family medical and genetic information, a patient's historical insurance claim information, a patient's employment record information, a patient's criminal record information, a patient's financial information, a patient's driving record information, etc.

The systems and methods of the present disclosure may further receive data from, and/or may transmit data to, a Health Information Exchange. A Health Information Exchange (HIE) is a database and data exchange server that collects, stores and sharing electronic health information among doctors' offices, hospitals, labs, radiology centers, and other health organizations. The Office of the National Coordinator for Health Information Technology (ONC), part of the U.S. Department of Health and Human Services, defines the Nationwide Health Information Network (NHIN) as “the set of standards, specifications and policies that enable the secure exchange of health information over the Internet.”

The 2009 Health Information Technology for Economic and Clinical Health Act (HITECH Act) set the goal of having an operative NHIN by 2014, when it will be possible to share individual health information locally, regionally, and nationally. While the 2014 goal is probably a stretch, HITECH-funded HIE demonstration projects are now underway in all states. As HIEs link to one another through the Internet, your health information will become available to health care providers all over the U.S.

HIEs allow access to health information by health care personnel, providing safer, more timely, efficient, patient-centered care. HIE allows doctors and nurses treating patients in a hospital or doctor's office to access a patient's medical history. For example, doctors can review recent lab results whether the test was conducted at your primary care provider, at the hospital, or at participating labs across the State. Because all authorized doctors and medical personnel see the same health information through the HIE, the HIE reduces errors, avoids unneeded duplication of tests and procedures, and consequently, reduces medical bills. Consider the many types of information that patient's health care providers compile about them. HIEs share information like lab test results, pathology results, diagnostic test images and results (such as radiology and other imaging diagnostics), prescription history, demographics, allergies, health care provider treatment orders, patient care summaries, provider visit reports, and referrals.

The systems and methods of the present disclosure may receive data from an HIE and analyze these sources of data, using a clinical analysis module, to produce output data representative of healthcare code(s). For example, a Health Insurance Portability and Accountability Act (HIPAA) approved document may be generated and automatically sent to an insurance carrier, a primary care physician, the patient and to an HIE database.

Healthcare codes, as referenced herein, may reflect code classifications including: topographical codes (e.g., TA codes, TH codes, TE codes, SNOMED T axis codes and MeSH A axis codes), diagnostic codes (e.g., general ICD-10 and ICD-9 codes, ICPC-2 codes, NANDA codes, Read codes, SNOMED D axis codes, specialized ICD-O, ICSD, ICHD, ILDS, DSM-IV or BPA codes); procedural codes (e.g., HCPCS (CPT, Level 2) codes, ICD-10 PCS codes, ICD-9-CM Volume 3 codes, NIC codes, SNOMED P axis codes, OPS-301 codes, Read codes/OPCS-4 codes, CCAM codes, ICHI code, or LOINC code); pharmaceutical codes (e.g., ATC codes, NDC codes, SNOMED C axis codes, or DIN codes); and outcomes codes (e.g., NOC codes).

For example, the Anatomical Therapeutic Chemical (ATC) Classification System is used for the classification of drugs. It is controlled by the WHO Collaborating Centre for Drug Statistics Methodology (WHOCC), and was first published in 1976. This pharmaceutical coding system divides drugs into different groups according to the organ or system on which they act and/or their therapeutic and chemical characteristics. Each bottom-level ATC code stands for a pharmaceutically used substance, or a combination of substances, in a single indication (or use). This means that one drug can have more than one code: acetylsalicylic acid (aspirin), for example, has A01AD05 as a drug for local oral treatment, B01AC06 as a platelet inhibitor, and N02BA01 as an analgesic and antipyretic. On the other hand, several different brands share the same code if they have the same active substance and indications.

In addition to generating healthcare codes, the output of the present systems and methods may be used for patient care management to help the patient align with services related to benefits, such as a medication formulary. Furthermore, the output may assist the patient to insure her medical home is intact and to interact with her primary care physician. From a continuity perspective, the output may move things, such as treatment, along and tie things up for quality care improvement. An output document may be delivered to a patient's physician, including a transcript from a teleinterview, in, for example, paper form or electronic medical records (emr). An output may include information to a patient for self treatment information in a patient pro-positive form to maximize what patients can do for their health (themselves).

Medical data related to physical examinations, blood tests, urinalyses, EKGs, and a host of other diagnostic testing may be procured to assess risk. Mobile examination may offer a full-service medical evaluation package that may be driven by board-certified physicians, as well as highly qualified nurses and physician assistants. Mobile examination services, united with computer systems and related software, may allow accurate, high-tech alternative to traditional methods of assessing risk. This type of mobile approach to gathering real-time medical data may enable informed decisions and limits the risk of medical exposure. This information may also allow insurance companies to perform a comprehensive evaluation of an applicant's insurability while reducing the time related to the application cycle and the ultimate issuance of insurance. Review of patient medical charts may provide additional data for determining a healthcare code. The systems and methods of the present disclosure may provide customized and configurable chart review and data collection that meet unique needs.

The systems and methods of the present disclosure may retrieve medical records and exchange related information with health care providers. By fusing advanced medical practices, the systems and methods of the present disclosure may provide an attending physician statement (APS) process that garnishes solid, accurate medical data in a time format. The systems and methods may provide fully automated custom applications, as well as Internet options that include ordering, authorization attachment, real-time status, and downloading records to a desktop in a Health Insurance Portability and Accountability Act (HIPAA) compliant process.

The systems and methods of the present disclosure may provide legal services specialized in servicing the unique needs of law firms and insurance carriers involved in litigation. From determining and accessing merits of any given case to obtaining documents to prove or disprove an injury or claim, the systems and methods of the present disclosure may provide information gathering and document-retrieval services.

The systems and methods of the present disclosure may provide information that is complete and concise. For example, the systems and methods may cleanse insurance applications that are submitted with incorrect, medically unclear, and missing information. Through a combination of techniques, information is gathered while having the ability to clarify missing information or facilitate the collection of missing forms and/or signatures in real time. The inability to begin the insurance underwriting process with an accurate and precise application can have a costly effect on the enterprise bottom line.

The systems and methods of the present disclosure may provide the ability to track such things as employee production, time, money, and a host of other factors, which allows for the effective management of the entire health care process. By applying advanced business practices, the methods and systems of the present disclosure may, at the touch of a button, provide various reporting tools. These tools may assist in the day-to-day aspects of producing a quality health care process and experience for all involved. By combining the cause (content and structure) and effect (production), the systems and methods of the present disclosure turn workplace data into quality information. Thus, the systems and methods make accurate decisions based on knowledge, rather than intuition.

The systems and methods of the present disclosure may provide insurers teleunderwriting services that encompassed applications and medical history via telephone interviews. Using the systems and methods of the present disclosure, qualified nurses, physician assistants, and doctors may telephonically gather medical information, assess insurance risk and make informed decisions. For example, the systems and methods may implement a structured, reflexive, questionnaire, that is designed by medical professionals, to yield medical information that is risk significant.

The systems and methods of the present disclosure may receive over the counter and prescription drug information (Rx information) related to medications that a patient has taken, is taking, or has been prescribed. The prescription drug information may be received from SureScripts, for example.

The systems and methods of the present disclosure may prove expert underwriting systems, rules-based engines, and predictive modeling. It's one concept called by many names, all defined the same way machines replacing people. For example, the systems and methods may combine teleinterviewing with a patient, insurance underwriting software, and artificial intelligence to create a rules-based engine.

Clinicians may interact with an intelligent system that include business rules and medical rules and generate data representative of a patient profile centered around risk. For example, the systems and methods may have data on a front end that determines if patient data indicates that they have X disease, or take X drugs, the systems and methods will load related questions. As a result, subsequent questions may be tailored dynamically based on an answer to a previous question. For example, if a patient indicates that she is pregnant (i.e., a medical rule), the system may determine that she will be asked questions about a new beginnings program if that carrier has this program requirement (i.e., a business rule).

The present systems and methods may only get pieces of information to generate code. For example, based on ICD-10, different extensions may be used to drive an insurance risk assessment. For example, three extensions may be used to determine details regarding a diabetic. Five extensions may be used to determine complications of the disease. The systems and methods may drive a Hemoglobin; glycosylated (A1C) test. Current procedural terminology (CPT) code 83037 may be billed when a Hemoglobin; glycosylated (A1C) test is performed in a provider's office using a device cleared by the food and drug administration (FDA) for home use. Generally, the present systems and methods may determine what medication a patient is currently taking and what works/does not work for the patient.

A health risk assessment system may be care driven. Alternatively, a health risk assessment may include clinical coding practices including a government defined risk stratification component. For example, from an insurance carrier perspective, a weighted distribution of particular Anatomical Therapeutic Chemical (ATC) Classification System codes may be used to determine risk. Furthermore, the government may identify fifty things that will result in the most expense. Accordingly, these fifty things will imply high risk stratification.

Today's patient with diabetes may have been pre-diabetic last year. Not only is the patient sicker today, but he or she probably generates higher costs than a year ago. Risk stratification is a tool for identifying and predicting which patients are at high risk or likely to be at high risk and prioritizing the management of their care in order to prevent worse outcomes in this case, amputation, blindness or death. Put simply, to risk-stratify patients is to sort them into high, moderate and low health risk tiers. Risk stratification aligns a practice's very limited time and resources to prioritize the needs of its patient population. It can and should involve sophisticated algorithms and robust registries, but it relies just as much on patient experience and physician judgment. Risk stratification is an intentional, planned and proactive process carried out at the practice level to effectively target clinic services to patients.

Three goals for risk stratification: 1. Predict risks, 2. Prioritize interventions and 3. Prevent negative outcomes (e.g., disability and death—as well as unnecessary costs). Perhaps the most important source of data is the patient. Patient Activation Measures (PAM), screening and health risk assessments all have predictive value. But so does asking “Do you think your health is ‘good,’ ‘fair’ or ‘poor’?” PAM is a tool that gauges the knowledge, skills and confidence essential to managing one's own health and health care. Risk stratification is dynamic and needs to be updated for any given patient.

The systems and methods of the present disclosure may receive data from at least one of the following: WebMD—provides a wealth of health information and tools for managing your health from an award-winning web site, which is continuously reviewed for accuracy and timeliness; HealthCentral—provides a collection of web sites providing trusted medical information from doctors, researchers, and expert patients, as well as news, information, video, and other multi-media content on health-related subjects; wrongDiagnosis—is one of the world's leading providers of online medical health information. The site is an independent, objective source of factual, mainstream health information for both consumers and health professionals; myOptumHealth—health care and medical information for healthy living; the Merck Manuals—the medical library; Mayo Clinic—is a not-for-profit medical practice dedicated to the diagnosis and treatment of virtually every type of complex illness; Yahoo! Health—is an ideal starting point to find virtually anything or anyone health-related on the Web; CNN Health—Medical, Mental and Dental Treatment—Beauty, Nutrition and Fitness; Discovery Health—source for health and wellness info, tips, tools, and support; National Institutes of Health—the nation's medical research agency; Uihealthcare.com—University of Iowa Hospitals and Clinics; or eMedicine—the continually updated clinical reference.

The present systems and methods may produce a patient health risk assessment. The health risk assessment may be used as a revenue adjustment for an associated insurance provider. The health risk assessment may be further used to match a patient up with a licensed physician in the patient's state. A patient profile centered around risks may form a part of the health risk assessment. The systems and methods may determine particular people, as well as, a health risk for a population of people. In any event, the present systems and methods may include programmatically written rules and the systems and methods may be configured to determine a classification of risk for particular individuals or groups of individuals. Anyone who has a disease will have a code (ICD 9 or 10, for example). The present systems and methods may determine all codes and the right codes for any given patient. A telephone interview with a patient may be tied to general patient medical records to maximize information for insurance carriers as to the risks they have or do not have.

This detailed description is to be construed as exemplary only and does not describe every possible embodiment, as describing every possible embodiment would be impractical, if not impossible. One could implement numerous alternate embodiments, using either current technology or technology developed after the filing date of this application.

What is claimed is:

1. A computer implemented dynamic information gathering method for generating data representative of healthcare codes, the method comprising:
receiving, at one or more processors, data representative of member non-personal information and data representative of member non-HIPAA information;
automatically generating, using one or more processors, data representative of pre-call information, wherein the data representative of the pre-call information is based, at least in part, on the data representative of the member non-personal information and the data representative of the member non-HIPAA information;
receiving, at one or more processors, data representative of member personal information, wherein the member personal information is remotely obtained via a series of questions and a series of corresponding answers from the member and wherein the processor dynamically determines at least one question based on the data representative of the pre-call information; and
automatically generating, using one or more processors, data representative of at least one healthcare code associated with the member based on the data representative of the member personal information.

2. The method of claim 1, further comprising:
receiving, at one or more processors, data representative of at least one medical rule, wherein the data representative of the member personal information is generated based on data that is remotely obtained via a series of questions to the member and a series of corresponding answers from the member and wherein the processor dynamically determines at least one second question based on an answer to a first question and further based on the data representative of the at least one medical rule.

3. The method of claim 1, further comprising:
receiving, at one or more processors, data representative of at least one business rule, wherein the data representative of the member personal information is generated based on data that is remotely obtained via a series of questions to the member and a series of corresponding answers from the member and wherein the processor dynamically determines at least one second question based on an answer to a first question and further based on the data representative of the at least one business rule.

4. The method of claim 1, further comprising:
receiving, at one or more processors, data representative of member HIPAA information, wherein the data representative of the at least one healthcare code associated with the member is further based on the data representative of member HIPAA information.

5. The method of claim 4, further comprising:
transmitting, using one or more processors, the data representative of the at least one healthcare code associated with the member to a government edge server.

6. The method of claim 1, further comprising:
automatically generating, using one or more processors, at least one of: a member report, a physician report or an insurance carrier report, based, at least in part, on the data representative of at least one healthcare code associated with the member.

7. A computer system for remotely and dynamically gathering information that may be used to generate data representative of healthcare codes, the computer system comprising:
a member non-personal information receiving module stored on a memory that, when executed by a processor, causes the processor to receive data representative of member non-personal information;
a member non-HIPAA information receiving module stored on a memory that, when executed by a processor, causes the processor to receive data representative of member non-HIPAA information;
a pre-call data generation module stored on a memory that, when executed by a processor, causes the processor to automatically generate data representative of pre-call information, wherein the data representative of the pre-call information is based, at least in part, on the data representative of the member non-personal information and the data representative of the member non-HIPAA information; and
a member personal information receiving module stored on a memory that, when executed by a processor, causes the processor to generate data representative of member personal information, wherein the member personal information is remotely obtained via a series of questions and a series of corresponding answers from the member and wherein the processor dynamically determines at least one question based on the data representative of the pre-call information.

8. The computer system of claim 7, further comprising:
a healthcare code generating module stored on a memory that, when executed by a processor, causes the processor to automatically generate data representative of at least one healthcare code associated with the member based on the data representative of the member personal information.

9. The computer system of claim 7, further comprising:
a medical rule receiving module stored on a memory that, when executed by a processor, causes the processor to receive data representative of at least one medical rule, wherein the data representative of the member personal information is generated based on data that is remotely obtained via a series of questions to the member and a series of corresponding answers from the member and wherein the processor dynamically determines at least one second question based on an answer to a first question and further based on the data representative of the at least one medical rule.

10. The computer system of claim 7, further comprising:
a business rule receiving module stored on a memory that, when executed by a processor, causes the processor to receive data representative of at least one business rule, wherein the data representative of the member personal information is generated based on data that is remotely obtained via a series of questions to the member and a series of corresponding answers from the member and wherein the processor dynamically determines at least one second question based on an answer to a first question and further based on the data representative of the at least one business rule.

11. The computer system of claim 7, further comprising:
a HIPAA data receiving module stored on a memory that, when executed by a processor, causes the processor to receive data representative of member HIPAA information, wherein the data representative of the at least one healthcare code associated with the member is further based on the data representative of member HIPAA information.

12. The computer system of claim 11, further comprising:
a healthcare code data transmitting module stored on a memory that, when executed by a processor, causes the processor to transmit the data representative of the at least one healthcare code associated with the member to a government edge server.

13. The computer system of claim 7, further comprising:
a report generating module stored on a memory that, when executed by a processor, causes the processor to automatically generate at least one of: a member report, a physician report or an insurance carrier report, based, at least in part, on the data representative of at least one healthcare code associated with the member.

14. A non-transitory computer-readable medium storing instructions for remotely and dynamically gathering information that may be used to generate data representative of healthcare codes, the non-transitory computer-readable medium comprising:
a member non-personal information receiving module that, when executed by a processor, causes the processor to receive data representative of member non-personal information;
a member non-HIPAA information receiving module that, when executed by a processor, causes the processor to receive data representative of member non-HIPAA information;
a pre-call data generation module that, when executed by a processor, causes the processor to automatically generate data representative of pre-call information, wherein the data representative of the pre-call information is based, at least in part, on the data representative of the member non-personal information and the data representative of the member non-HIPAA information; and
a member personal information receiving module that, when executed by a processor, causes the processor to generate data representative of member personal information, wherein the member personal information is remotely obtained via a series of questions and a series of corresponding answers from the member and wherein the processor dynamically determines at least one question based on the data representative of the pre-call information.

15. The non-transitory computer-readable medium of claim 14, further comprising:
a healthcare code generating module that, when executed by a processor, causes the processor to automatically generate data representative of at least one healthcare code associated with the member based on the data representative of the member personal information.

16. The non-transitory computer-readable medium of claim 14, further comprising:
a medical rule receiving module stored on a memory that, when executed by a processor, causes the processor to receive data representative of at least one medical rule, wherein the data representative of the member personal information is generated based on data that is remotely obtained via a series of questions to the member and a series of corresponding answers from the member and wherein the processor dynamically determines at least one second question based on an answer to a first question and further based on the data representative of the at least one medical rule.

17. The non-transitory computer-readable medium of claim 14, further comprising:
a business rule receiving module that, when executed by a processor, causes the processor to receive data representative of at least one business rule, wherein the data representative of the member personal information is generated based on data that is remotely obtained via a series of questions to the member and a series of corresponding answers from the member and wherein the processor dynamically determines at least one second question based on an answer to a first question and further based on the data representative of the at least one business rule.

18. The non-transitory computer-readable medium of claim 14, further comprising:
a HIPAA data receiving module that, when executed by a processor, causes the processor to receive data representative of member HIPAA information, wherein the data representative of the at least one healthcare code associated with the member is further based on the data representative of member HIPAA information.

19. The non-transitory computer-readable medium of claim 18, further comprising:
a healthcare code data transmitting module that, when executed by a processor, causes the processor to transmit the data representative of the at least one healthcare code associated with the member to a government edge server.

20. The computer system of claim 14, further comprising:
a report generating module that, when executed by a processor, causes the processor to automatically generate at least one of: a member report, a physician report or an insurance carrier report, based, at least in part, on the data representative of at least one healthcare code associated with the member.
